(19) United States
(12) Patent Application Publication
(10) Pub. No.: US 2012/0263949 A1
(43) Pub. Date: Oct. 18, 2012

(54) RUBBER TO METAL BONDING FILM

(75) Inventors: Scott W. Wollack, Peru, IL (US); Thomas H. Malpass, Ottawa, IL (US)

(73) Assignee: TEE GROUP FILMS, INC., Ladd, IL (US)

(21) Appl. No.: 13/445,548

(22) Filed: Apr. 12, 2012

Related U.S. Application Data
(60) Provisional application No. 61/474,354, filed on Apr. 12, 2011.

(51) Int. Cl. C09J 7/02; B32B 15/06; B32B 27/28; B32B 7/12; B32B 27/32

(52) U.S. Cl. 428/355 BL; 428/343; 428/355 R; 428/355 AC; 428/355 CN; 428/457

(57) ABSTRACT

The present disclosure relates to a thermoplastic film containing an adhesive layer which is heat activated and adhered to metal sheeting and another layer which is heat activated and adhered to rubber.

### PRIORITY CLAIM

This application claims priority under 35 U.S.C. §119(e) to U.S. Provisional Application Ser. No. 61/474,354, filed Apr. 12, 2011, which is expressly herein incorporated by reference in its entirety.

### BACKGROUND

Rubber coated metal sheeting is used in various industries and for a number of applications. In the current manufacturing processes, solvent based adhesives are applied to the metal. These adhesives are designed to chemically react with the rubber material. The rubber material bonds to the metal using the chemical adhesives during the vulcanization process in which heat and pressure are applied for several hours. The majority of the chemicals used during this process are considered pollutants and health hazards.

Currently in the industry metal sheeting is cleaned, primed and painted with a liquid bonding agent. DOW Chemical® and Lord Chemical® have developed liquid adhesive systems currently used to adhere metal and rubber together. These systems are sold under the trade names Dow Megum®, Dow Thixon®, and Lord Chemical Chemlok®. Improvements can be made as these are liquid systems which, in some cases, require the metal surface to be primed, require use of EPA regulated processes, and require a large amount of preparation time for the liquid adhesive systems to reach optimal bonding conditions. In all applications the liquid bonding agent is “painted” onto the metal sheeting. A polymer film capable of adhering metal and rubber together addresses many of these concerns.

In the current process known in the industry, the metal surface is cleaned, primed, and then the bonding agents are applied in a process similar to painting with an airbrush. In each step hours of time is consumed preparing the metal surface. When priming and applying the adhesive much more time is required to allow the primer and solvents to dry or “set up” to the point where rubber can be applied. Also, because of the hazards of the primers and solvents, heavy environment regulations are in place to protect the employees and the surrounding environment.

### SUMMARY

According to the present disclosure, a polymer film is configured to be used to bond a rubber layer to a metal substrate. The polymer film is designed to eliminate the need for hazardous chemical materials.

In illustrative embodiments, a polymer film, is composed of at least two layers and is manufactured with either a smooth or embossed texture, wherein one layer is a polymeric adhesive designed to bond to metal and the second layer is a polymeric adhesive designed to bond to rubber. The resultant film allows a rubber to be bonded to a metal substrate without the use of chemical solvents and aerosols which has significant advantages.

The present disclosure relates to a multi-layer polymer film having a thermoplastic adhesive on each side where one is capable of bonding to metal and the other is capable of bonding to rubber. The film is used as a replacement for primers, paints, and chemical bonding agents. It also provides a one-step process which greatly decreases the overall cost of production. The film provides precision thickness control over liquid solvents with uniform coverage. The thermoplastic adhesive polymer film is non-regulated making it easier to handle and store and reduces health hazards, pollution and disposal costs. All these in turn increase production efficiencies.

In the case of the present disclosure, the metal surface is cleaned then heated to a temperature where the side of the film designed to adhere to metal will bond to the metal surface. This is made possible through use of a novel extrudable thermoplastic adhesive composition to eliminate the need for chemical primers, paints, and chemical glues, all of which give off chemical vapors which need to be monitored.

The adhesive composition includes the following components: an extrudable polymer backbone reacted with a polar functional moiety capable of forming covalent bonds between the polymer and the metal. This polymer functional moiety can further be diluted with various thermoplastic extrudable polyolefin materials.

The adhesive composition may also contain 0.1% to 75% by weight particulate filler, capable of reacting in part with the polar functional moiety. This in turn opens up ionic bonding sites in the form of anions on the particulate filler allowing ionic bonding to occur to the cations in the metal. It must be noted that the polar functional moiety provides sufficient bond strength to the metal surface in its own capacity, however, the particulate filler imparts certain chemical and mechanical properties which are highly desirable.

Optionally an additional quantity of thermoplastic extrudable polyolefin material can be used to make up the remainder of the volume if necessary. The adhesive composition, when optimized, allows for a polar covalent chemical bond to form between the polymer backbone and the metal via the functional moiety. By definition, a polar covalent bond allows each atom to have a residual or partial charge, similar to ionic bonding in that the electrons are shared not transferred.

Further, through the use of particulate fillers, which contain charged electrons, incorporated into the film structure, an ionic bond can form between the particulate filler and the metal. Transition metal hydride complexes are also capable of forming hydrogen atoms that are released from the particulate filler. The ionic bond by definition is a complete or near complete transfer of an electron. This is allowed as a given percentage of the polar functional moiety in the thermoplastic adhesive. Once a polar covalent bond is formed this leaves a negative charge on the particulate filler which is a bonding site for the cations in the metal. This reaction is also capable of freeing hydride for metal bonding.

This process is achieved by the use of anhydrides, esters, and amides; metal salts of unsatured carboxylic acids; and imides placed into the polar functional moiety. The result is a reaction with a hydrogen atom or alcohol group on the particulate filler in a redox reaction forming an acid. The removal of the hydrogen atom or alcohol group from the particulate filler will leave a negative charge on the remaining particulate filler molecule.

The present disclosure provides an unbreakable chemical bond between the metal and the polymer film which can withstand weathering, chemical exposure, bending & forming. The ionic bonding, imparted by the particulate filler, ensures that the bond to the metal surface remains intact when the article is exposed to water for significant periods of time. The resultant polymer film can be laminated to metal sheeting in a one step process through the use of heat only.

The particulate filler in the thermoplastic extrudable adhesive composition impacts the melting of the thermoplastic by reducing the energy requirement (Joules/gram) to achieve melting of the thermoplastic layer. The particulate filler retains the initial energy put in longer than the thermoplastic retains the energy put in. The energy is given off in the form of heat, which increases the time the thermoplastic is in a molten state to allow for further covalent and ionic bonding to occur in turn increase the strength of the overall bond of the polymer to the metal.

The particulate filler in the thermoplastic extrudable adhesive composition, by imparting the melting of the thermoplastic by reducing the energy requirement (Joules/gram) to achieve melting of the thermoplastic layer, allows for faster lamination speeds of the polymer film. The layer which bonds to rubber has a chemical makeup which readily crosslinks to the rubber during autoclave vulcanization. The layer which bonds to the rubber may contain crosslinking agents to further enhance the chemical bond strength between the polymer film and the rubber.

In the present disclosure incorporates a thermoplastic adhesive into the polymer film structure which is activated and bonded with the use of heat. Heat is already present in the current autoclave process. This eliminates the need for a liquid bonding agent to adhere the metal and rubber together. An important component of the polymer film is the adhesives used to secure the film to the metal and rubber.

Some important properties for both extrudable adhesive are as follows. First the adhesive or “sticking” properties must be strong enough so that the polymer film does not separate from the metal even after being exposed to weathering, such as a salt brine solution, and chemical agents, such as battery acid, peroxides, herbicides, and pesticides. Also, the film must be able to bend and curve. The metal/rubber sheeting can be formed into articles such as earthquake shock absorbers, transmission shock absorbers, rubber flooring, building panels, sound deadening and several military applications.

These and other features and advantages of the invention will become further apparent from the following detailed description of the presently preferred embodiments, read in conjunction with the accompanying examples and drawings. The detailed description, examples, and drawings are intended to be illustrative rather than limit, with the scope of the invention being defined by the appended claims and equivalent thereof.

### BRIEF DESCRIPTION OF THE DRAWINGS

The detailed description particularly refers to the accompanying figures in which:

FIG. 1 is a cross sectional view (not to scale) showing the thermoplastic polymer film formed from multiple layers;

FIG. 2 shows the heat lamination process, showing a metal sheet exiting an oven and a film material is pressed to either one or two sides;

FIG. 3 shows the metal sheet center with polymer film laminated to both sides (not to scale); and

FIG. 4 shows the metal sheet bonded to the rubber through use of the polymer film (not to scale).

### DETAILED DESCRIPTION

While the present disclosure may be susceptible to embodiment in different forms, there are shown in the drawings, and herein will be described in detail, embodiments with the understanding that the present description is to be considered an exemplification of the principles of the disclosure and is not intended to limit the disclosure to the details of construction and the arrangements of components set forth in the follow description or illustrated in the drawings.

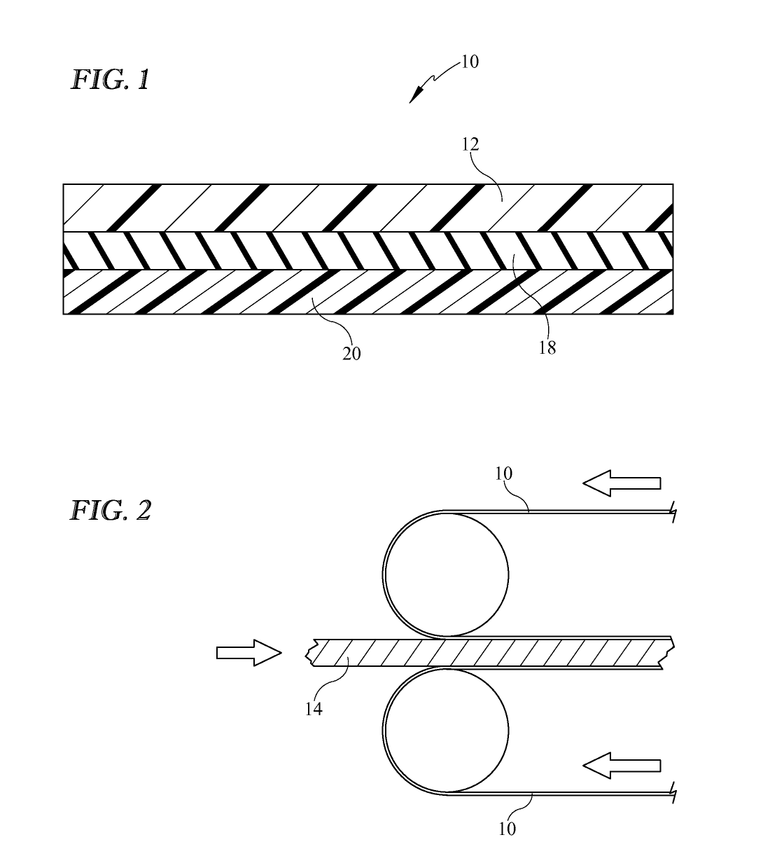

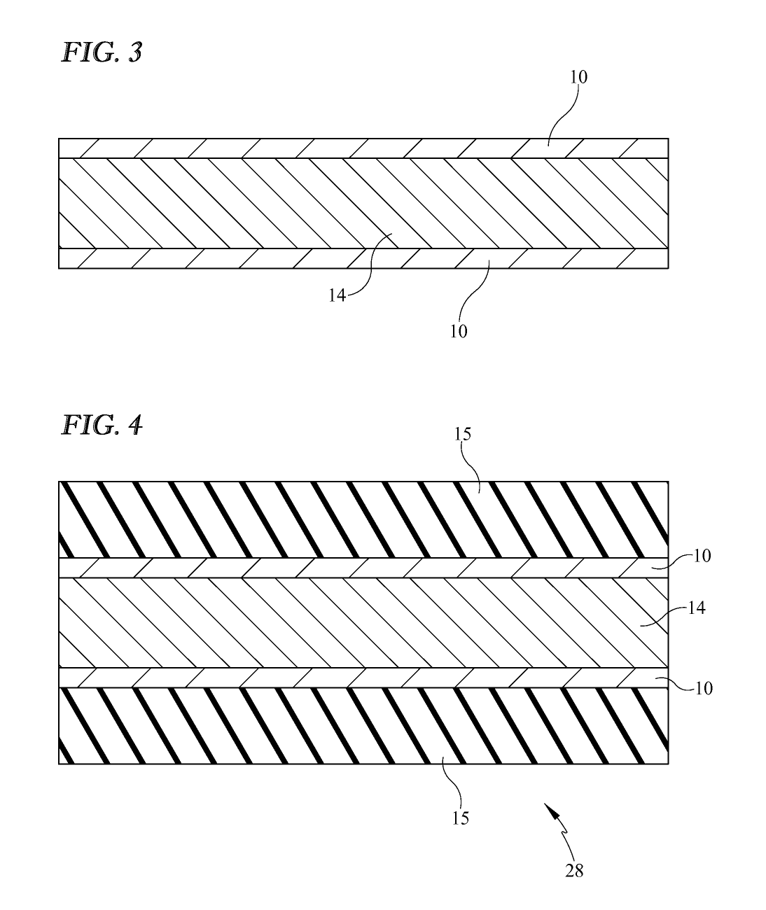

A polymer film or sheet 10 is made up of multiple layers and includes at least one thermoplastic adhesive layer 12 that is configured to bond to a metal substrate 14 and at least one thermoplastic adhesive layer 20 designed to bond to a rubber substrate 15, as shown in FIG. 1 for example. The polymer film 10 can be extruded onto metal substrate 14 and onto a rubber substrate 15. The resultant rubberized metal sheeting 28 can be used to form a finished product such as piping for use as culverts or other applications, as shown in FIGS. 2 and 3 for example. The thermoplastic adhesive layer 12, in one example can be a high density polyethylene (HDPE) and is preferably a polar compound made from maleic anhydride, ethylene acrylic acid, ethylene methyl acrylate, or ethyl-methyl acrylic acid or a mixture of said. The thermoplastic adhesive layer 12 may also contain a particulate filler or be rubber modified and contain optional quantities of additional thermoplastic resin layers.

The polar compound allows for an actual chemical bond to be created between the thermoplastic adhesive layer 12 and the metal surface. The maleic anhydride attacks the surface of the metal allowing the polar portion of the molecule to attach to the metal molecule. If a particulate filler is added to the thermoplastic adhesive layer 12, the particulate filler will allow the thermoplastic adhesive to become molten with less energy when heat is applied. If the thermoplastic adhesive layer 12 is rubber modified, the energy input into the polymer will distribute more evenly allowing for a more consistent bond with the metal substrate 14.

The thermoplastic adhesive layer 20 used to bond to the rubber substrate 18 is an ethyl-vinyl acetate material containing at least 12% vinyl acetate in the co-polymer which is able to cross-link to the rubber. The thermoplastic adhesive layer 14 may or may not contain cross-linking agents to increase bond strength to the rubber substrate 18 during vulcanization. Cross-linking agents can be used to increase the bond strength. Thermally active ingredients used to cause cross-linking can range from about 0.001% to about 1% by weight of the total adhesive layer.

The film or sheet 10 can be manufactured in a single step in a co-extrusion process or in a two step process using extrusion coating to bond two layers. The film 10 may include an embossed pattern to reduce the surface friction and increase surface area. The thermoplastic adhesive layer 12 is configured to be bonded to the metal substrate 14 and includes from about 0.001% to about 25% maleic anhydride and from about 5% to about 32% ethylene acrylic acid co-polymer, ethylene methyl acrylate copolymer, or ethyl-methyl acrylic acid co-polymer by overall volume.

The thermoplastic adhesive layer 12 is configured to sufficiently bond to the metal substrate 14 without delaminating and can withstand various common chemicals and protects the resultant metal sheeting 28 formed from the elements as it is used out doors.

The adhesive component used in the manufacture of the film 10 includes an active ingredient based on an extrudable polymer or copolymer backbone which is grafted or otherwise reacted with a polar monomer to impact a polar functionality of the adhesive. Suitable base polymers include but are not limited to polyethylene, polypropylene, and ethyl-vinyl acetate. Of the several types of moieties which can be grafted or reacted to the polymer backbone maleic anhydride is preferred with concentration of 0.01% to 15% by weight of the polymer backbone. Overall, the active ingredient, herein defined as one of the polymers stated above reacted with a functional moiety, constitutes 1% to 97% by weight of the adhesive composition.

Maleic Anhydride is preferred because of its ability to react it with a variety of base polymers. The base polymers have varying characteristics, including but are not limited, to melting point, vapor transmission, and chemical resistance. These characteristics allow the polymer film or sheet 10 to be altered to meet varying field requirements or based on the type of base polymer selected. This is advantageous because some applications may expose the polymer to heated liquids, various chemicals, and areas of constant high humidity. Selecting the correct base polymer, which is grafted to the maleic anhydride adhesive layer 12, will increase the overall life of the ultimate product compared to standard “off the shelf” polymer film products.

A particulate filler added into the thermoplastic adhesive layers 12, 20 reduces the amount of required energy that is needed to allow the thermoplastic adhesive layers 12, 14 to become molten. The particulate filler does not reach its melting point given the amount of heat and energy applied and the overall volume of material which will become molten and is limited to the thermoplastic adhesive material.

As the thermoplastic adhesive layers 12, 20 cool the energy stored in the particulate filler will be transferred into the thermoplastic adhesive in the form of heat. The release of heat from the particulate filler increases the amount of time required for the thermoplastic adhesive layer 12 to fully solidify and allows the polar molecules in the compound more time to react with the surface of the metal and setup a chemical bond thus creating a stronger bond between the thermoplastic adhesive layer 12 and the metal substrate 14. By using the multilayer polymeric adhesive the thickness of the film can be precisely controlled and uniform coverage can be achieved. The resultant film 10 is easier to handle and store, creates minimal pollution, reduces health hazards, reduces cleanup and disposal costs.

Particulate fillers can be organic and inorganic and include, but are not limited to, talc, mica, alumina, wallastonite, clay, glass, spheres, silica, titanium, wood flour, and mixtures including one or more of the these. Talc is the presently the preferred filler. Other fillers are less preferred due to their reactivity with the polar compound making the material inert. The particulate filler can constitute 1% to 75% by weight of the total adhesive.

Several types of extrudable thermoplastic adhesives do not contain a filler component. However, some of these thermoplastic adhesives can be mixed with a particulate filler in the amounts stated above to create an adhesive composition that could be used in this application. These include but are not limited to Dow Primacore™, DuPont Admer™, DuPont Nucrel™, Equistar Plexar™, Dow Rohm & Hass Tymor™, Exxon Optima™, and Westlake Tymax™. The use of a particulate filler with these thermoplastic adhesives would fall within the scope of the disclosure.

The thermoplastic adhesive material can further be modified with the use of rubber. The rubber is generally an ethylene propylene diene Monomer (M-class) rubber (EPDM) but less common rubber types such as styrenes have been used. The rubber can be added either before or during the film manufacturing process. The EPDM can constitute 0.5% to 15% by weight of the total adhesive.

When heat and energy are applied to the thermoplastic adhesive material the rubber component will initially take longer to absorb the energy. Once the energy starts to be absorbed the rubber component will evenly dispersed the energy throughout the film 10. Even heat distribution ensures that one section of the film 10 does not take in more energy than is required to allow for the thermoplastic adhesive to melt to activate the polar compound. This results in even bond strength of the polymer film 10 to the metal substrate 14 across the area of the metal surface.

An example film 10 used for lamination of a rubber substrate 15 to a metal substrate 14 consisted of two layers and had an overall thickness of approximately five mils, as shown, for example, in FIG. 1. The first thermoplastic layer 12 was a blend of HDPE, maleic anhydride adhesive rubber modified, and a talc filler. The second thermoplastic layer 20 was an EVA which can contain 0.1% to 5% cross-linking agents. The rubber was added at the compounder and was approximately 10% of the polymeric adhesive.

In this example, the oven used was set to 400° F. The metal exiting the oven was approximately 350° F. when the film 10 was applied. Acceptable ranges for ideal bond strength using a HDPE base in the first layer would be from about 300° F. to about 450° F. The acceptable ranges for LDPE or LLDPE would be from about 275° F. to about 450° F. The acceptable ranges for PP would be from about 350° F. to about 500° F. The rubber sheeting 15 was then applied to the film 10 and additional heat and pressure were applied to cause the film 10 to bond to the rubber substrate 15 to form the resultant rubberized metal sheeting.

Referring to FIGS. 1 and 2, a multi-layer polymer film, generally designated as 10, is shown in a cross functional view. The film contains three essential components, A thermoplastic adhesive layer 12 configured to sufficiently bond to the metal substrate without delaminating and can withstand various common chemicals and weathering.

A core layer 18 which can be the same composition as the second thermoplastic adhesive layer, 20, or can be changed using various polymeric technology in order to improve performance of the overall polymer film depending on the final article application 28. An second thermoplastic layer 20 composed of a thermoplastic adhesive with a chemical composition capable of bonding to rubber 15.

In the preferred embodiment shown, the thermoplastic adhesive layer 12 capable of bonding to metal substrate 14, is placed down against the metal sheet's surface, as shown in FIG. 2. The center layer, 18, can be used to reinforce the adhesive layer 12, and can also be modified to improve the performance of certain characteristics such as heat and strength. The metal sheet, as shown in FIG. 2, was run through an oven heated in a range from about 325 degrees to about 600 degrees Fahrenheit. As the metal comes out of the oven a given amount of heat is lost to the environment. The thermoplastic polymer film 10, in roll form, is unwound with the thermoplastic adhesive layer, 12, facing toward the metal surface.

The metal surface can be constructed of any metal commonly used in sheeting, including but not limited to steel, cooper, aluminum, zinc, and various other metals and metal alloys. As explained below the adhesive employs a polar functionality which chemically reacts with a thin oxide coating appearing on the surface of most metals. Therefore, any metal or alloy which forms an oxide on its surface can be employed with this disclosure.

Further, through the use of particulate fillers incorporated into the film structure, an ionic bond can form between the particulate filler and the metal and free hydrides and the metal. The ionic bond by definition is a complete or near complete transfer of an electron. This is allowed as a given percentage of the polar functional moiety in the thermoplastic adhesive will polar covalent react and bond to atoms in the particulate filler. Once a polar covalent bond is formed this leaves a negative charge on the particulate filler or hydrogen atom which is a bonding site for the cations in the metal.

This process is generally achieved by the use of anhydrides, esters, and amides; metal salts of unsatured carboxylic acids; and imides placed into the polar functional moiety. The result is a reaction with a hydrogen atom or alcohol group on the particulate filler in a redox reaction forming an acid. The removal of the hydrogen atom or alcohol group from the particulate filler will leave a negative charge on the remaining particulate filler molecule.

Ionic bonding occurs between the particulate filler and the metal because metals are characterized by having a small number of electrons in excess of a stable, closed-shell electronic configuration. As such, they have the tendency to lose these extra electrons in order to attain a stable configuration, a property known as electropositivity. After the particulate filler is reacted with the polar moiety the reacted particulate filler contains an atom that is characterized by having an electron configuration just a few electrons short of a stable configuration. As such, they have the tendency to gain more electrons in order to achieve a stable configuration. This tendency is known as electronegativity.

When a highly electropositive metal is combined with a highly electronegative particulate filler or Hydride, the extra electrons from the metal atoms are transferred to the electron-deficient nonmetal atoms. This reaction is between metal cations and nonmetal anions, which are attracted to each other to form a metal salt. The adhesive composition used in the invention includes an active ingredient based on an extrudable polymer or copolymer backbone which has been grafted or otherwise reacted with a polar monomer to impart a polar functionality to the adhesive. Suitable polymer backbones include thermoplastic materials such as polyethylene, polypropylene, and copolymers of ethylene with other alpha-olefins, copolymers of propylene and with other alpha-olefins, copolymer of ethylene with ethylenically unsatured esters and their derivatives, and mixtures including any of these polymers.

Typical functional moieties which can be reacted with the polymer backbone to impart polarity include unsatured carboxylic acids, functional derivatives of the carboxylic acids including anhydrides, esters, and amides; metal salts of unsatured carboxylic acids; and imides. Of these, maleic anhydride is especially preferred. The maleic anhydride or other functional moiety can be thermally grafted, solution polymerized, or otherwise reacted onto the polymer backbone at a concentration of about 0.01-15% by weight of the polymer backbone, preferable about 0.5-10% by weight of polymer backbone, most preferable 1-5% by weight of the polymer backbone.

Overall, the active ingredient (defined as polyolefin reacted with functional moiety) can constitute between 1-100% by weight of the adhesive composition, with preferred amounts varying depending on the amount and type of the functional moiety reacted with the polymer backbone and amount of particulate filler added. The adhesive composition used in the invention also contains a particulate filler which is designed to reacted with the polar moiety creating iconic bonding sites. The filler will also reduce the amount of energy (Joules/gram) required to melt the thermoplastic portion of the adhesive. The filler will also retain heat allowing the thermoplastic portion of the adhesive to remain in a molten state longer providing more time for chemical bonds to form. The filler will also stiffen and rigify the adhesive without greatly affecting the chemical bonding the adhesive.

The particulate filler can be organic or inorganic, and can constitute about 0.1-75% by weight of the total adhesive composition, preferable about 6-45% by weight, most preferable about 10-20% by weight. The filler particle size will affect the percentage of filler used in the adhesive. Particle sizes with an average diameter less than 1 micron will require percentages less than 3% by weight. This is due to an increase in surface area of smaller particle sizes. The greater the amount of surface area the more reaction with the polar functional moiety and this less percent filler by weight is required to get an equivalent bond.

Particulate fillers include but are not limited to, talc, mica, alumina, wallastonite, clay, glass sphere, titania, silicates, phosphate, wood flour, and mixtures including one or more of these. These are preferred as they react with the polar moiety forming ionic bonding sites.

An Oxo-Anion of silicate in a lattice structure is presently preferred with a negative charge of 4 or greater. Silicates can form several lattice structures with varying degrees of ionic bonding sites. Examples of these silicate molecules include Nesosilicates, Sorosilicates, Cyclosilicates, Inosilicates, Inosilicates.

An important feature of the filler is that it not be allowed to react excessively with the polar functional moiety in the adhesive. The result would be that the polar moiety reactive sites will be completely used up bonding to the particulate filler and the moiety would be rendered inert which would prevent polar covalent bonding to the metal surface. One way to control such a reaction is to chemically balance the percent filler by weight against the percent polar moiety by weight based on the number of potential active sites on the filler that the polar moiety can react with.

Another way is to coat an otherwise reactive filler with a less reactive or inert material (steric acid, behenic acid, mineral oil and so on) which physically shields the filler from the polar functional moiety from the majority of the polar moiety. Even after coating the particulate filler, some reaction is still occurs between the filler and polar moiety. It is preferred that 5-15% of the polar moiety react with the particulate filler to allow ionic bonding sites, again depending on the concentration of particulate filler.

How much particulate filler is used will depend on the strength and amount of the polar functional moiety reacted with the backbone polymer in the active ingredient (which affects how much, if any, of the active ingredient can be diluted). The adhesive composition may optionally contain one or more additional thermoplastic polyolefin-type polymers and co-polymer which are not reacted with a polar functional moiety. The unreacted polymer may simply serve as a diluent for the reacted polymer, and may include any of the polymers listed above as polymer backbones. The unreacted polymer may also serve as an adhesion promoter, and may include soft or rubbery materials such as ethylene-propylene rubber, butane-1 polymers and copolymers, ethylene vinyl acetate, and other soft materials. These softer materials help to evenly disperse the energy put into the thermoplastic adhesive.

Because of their elastic strength of the softer materials they will also consume energy during attempts to delaminate the film from the metal surface. As the adhesive is deformed during peeling the polymer chains of the adhesive are stretched. These softer materials will act as “rubber bands”, storing energy elastically and preventing abrupt failures of the film. When used, the optional additional polymer or polymers may constitute about 1-97% by weight of the adhesive composition depending on the type of material.

Whether or not an unreacted polyolefin is used, and how much, will depend on the strength and amount of the polar functional moiety reacted with the backbone polymer in the active ingredient (which affects how much, if any, of the active ingredient can be diluted). Also to be considered is how much particulate filler is added to the adhesive (which affects how much, if any, of the filler interacts with the active ingredient). Generally, the amounts and types of the active ingredient, filler, and unreacted polymer should be selected so that the amount of the functional polar moiety in the active ingredient, which is available for polar covalent bonding to the metal oxide surface and is not reacted with the filler constitutes about 0.01-5% by weight of the overall adhesive composition. Preferable, the amount of the polar functional moiety will be about 0.02-1% by weight of the adhesive composition, most preferable about 0.03-.5% by weight.

Several known extrudable adhesives do not contain a filler component or anhydrides, esters, and amides; metal salts of unsatured carboxylic acids; and imides, and are therefore not part of this invention. However, some of these adhesives can be mixed with a filler in the amounts stated above along with anhydrides, esters, and amides; metal salts of unsatured carboxylic acids; and imides to create an adhesive composition capable of both polar covalent and ionic bonding and thus useful in metal sheet lamination. Examples of these extrudable adhesives include PRIMACOR which is a family of low modulus, low density resins prepared by copolymerizing acrylic acid with ethylene and is available from DOW Chemical grafted polyolefin blend with hydrocarbon elastomers, BYNEL available from Du Pont, ADMER available from Mitsui Petrochemical Industries, PLEXAR available from Equistar, TYMEX available from Westlake, TYMOR available from Rohm & Hass a Division of DOW Chemical. Two very useful adhesives are polar moieties containing high density polyethylene sold by Equistar under the name PLEXAR and Rohm & Hass under the name TYMOR. Again these two particular extrudable adhesives do not contain fillers as sold but can be mixed with fillers to make adhesive compositions within the scope of the invention.

The production of mono-layer and multi-layer film is well known in the art, and all known techniques are available for use in accordance with the present invention. One preferred technique is the use of a multi-layer film line utilizing a co-extrusion channel feed block with the ability to make a minimum of two layers, an adhesive layer capable of bonding to metal, 12 and an adhesive layer capable of bonding to rubber 20. The metal adhesive layer, 12, contains the above discussed thermoplastic adhesive formulation containing a filler. The metal adhesive layer by percent of the overall film structure can be varied from 1-75% of the overall film.

The core layer can be used to change the properties of the film to perform based on the application of the finished laminated metal article without impacting the performance characteristics of either metal adhesive 12 or rubber adhesive layers 20. In one case the core layer may be composed of Linear Low Density Polyethylene to increase the elongation of the overall film product. In another case the core layer may be composed of Nylon vapor protection.

A core layer, 18, is in place for the purpose of adjusting film properties without affecting the properties of the other layers. The composition of the core layer will be different from application to application and customer to customer. In some cases a core layer is not needed. In other instances multiple film properties are needed that a single core layer would not provide. This would require more than one core layer. The sum of all core layers by percent of the overall film structure will vary based again on application and customer requirements.

The Adhesive Layer capable of Bonding to Rubber is generally composed of a polyolefin with branched chains in Atactic, Isotactic, or Syndiotactic configuration. The branch chains contain molecules which will readily react with crosslinking or coupling agents to chemically bond to rubber. Examples of these compounds induce Ethyl-Vinyl Acetate, Ethyl-Acrylic Acid, ethylene methyl acrylate, ethylene butyl acrylate, catalytic plastomers, and extrudable thermoplastic rubbers.

Using one of the above stated polymers, Ethyl-Vinyl Acetate, EVA. The polymer EVA is easily reacted with crosslinking and coupling agents, such as peroxide and sulfur commonly used in rubber vulcanization. However, several other polymer types with branched chains are also capable of chemically reacting to the rubber compound.

In many cases the crosslinking or coupling agent in the rubber compound will be sufficient to create a chemical bond to this layer of the polymer film. However, in cases where it is not sufficient a crosslinking or coupling agent may be added to the polymeric adhesive layer which bonds to the rubber. It is highly preferred that a liquid crosslinking agent be injected into the melt flow for even dispersion and chemical reaction across the surface area of the film. However, it has been shown that encapsulated peroxides can be added to the formulation in a blending process and introduced with the base polymer at the feed section of the extruder. However dispersion is less than desirable when done in this fashion.

It is important in the co-extrusion process that the crosslinking or coupling agents have a high enough reaction temperature that they do not active while extruding, laminating, or applying by hand. This is due to the fact that the other layer(s), in particular the layer that bonds to the metal surface, must be heated to higher temperatures because of their melting points. Crosslinking or coupling agents can be chosen with different reaction points to fine tune this. Generally an organic peroxide with a high decomposition temperatures is desirable to ensure that no reaction takes place during extrusion, lamination, or application.

Several crosslinking and coupling agents can be used including titanates and zirconates, organic peroxides, and sulfonics, which are capable of chemically bonding the polymer film to the rubber compound. One such crosslinking agent is Trigonox 311. Trigonox 311 is easily injected at temperatures up to 200 Celsius and has a half-life at 200 Celsius of 10 to 15 seconds before decomposition occurs. It should be noted that the peroxide decomposition is not only temperature but times depended. Thus longer dwell times at elevated temperatures, below 200 Celsius, still causes a reaction to occur. It is of great importance that the polymer film is quickly quenched and solidified before reaction of the peroxide occurs even at lower temperatures.

The half-life of the peroxide used will determine the percentage or injection rate. Crosslinking or coupling agents with longer half-lifes can be used at higher levels without worry of decomposition, vice versa for crosslinkers and coupling agents with lower half-lifes. Mostly this will depened on customer process conditions, what temperatures they are curing, and the type of rubber employed, Natural Butyl, EPDM, Silicone, etcetera. Thus the type and percentage of crosslinker or coupling agent is not stated as it varies greatly from application to application and the composition of the base polymer used in the layer however the use of these.

As shown in FIG. 2, after the metal, 14, is conveyed out of the oven it is ran through two lamination rolls located on the top and bottom of the metal sheet. The thermoplastic film 10 capable of bonding to metal, wraps the lamination rolls with the adhesive side facing away from the lamination rolls but toward the metal sheet surface. Under pressure from the lamination rolls, and using the remaining heat in the metal from the ovens, the film is laminated to the metal. After only a couple seconds a chemical bond has started to form between the metal and the thermoplastic adhesive. The metal/film composite is further conveyed into a water tank where the composite article is cooled to room temperature before being wound into a roll.

A rubber/metal article made in accordance with the present invention offers many benefits over the primers and solvents including faster preparation time, easy of storage and recycling, and eliminates health concerns due to exposure to chemicals.

While embodiments have been illustrated and described in the drawings and foregoing description, such illustrations and description are considered to be exemplary and not restrictive in character, it being understood that only illustrative embodiments have been shown and described and that all changes and modifications that come within the spirit of the disclosure are desired to be protected. The applicants have provided description and figures which are intended as illustrations of embodiments of the disclosure, and are not intended to be construed as constraining or implying limitation of the disclosure to those embodiments. There is a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure.

What is claimed is:

1. A multi-layer adhesive film for laminating a rubber material to a metal substrate comprising:
an first layer formed from a thermoplastic adhesive containing a functional polar moiety and from about 0.1% to about 75% of volume by percent weight of a particulate filler, the first layer configured to be bonded to the metal substrate; and
a second layer composed of a thermoplastic adhesive capable of bonding to the rubber material.

2. The multi-layer adhesive film of claim 1, wherein the multi-layer adhesive film can be heat laminated to the metal substrate and the metal substrate can be converted into articles of manufacture.

3. The multi-layer adhesive film of claim 1, wherein a crosslinking or coupling agent can be added to the thermoplastic adhesive of the second layer to increase the chemical bond strength to the rubber material.

4. The multi-layer adhesive film of claim 3, wherein the amount of crosslinker is varied depending on the half-life of the material, the rubber type, and the vulcanization process.

5. The multi-layer adhesive film of claim 3, wherein the crosslinking agent is in the form of peroxide.

6. The multi-layer adhesive film of claim 1, wherein the thermoplastic adhesive of the second layer may include from about 1% to about 97% of soft or rubbery materials, help disperse heat energy put into the thermoplastic adhesive during bonding to the rubber material.

7. The multi-layer adhesive film of claim 6, wherein the soft or rubbery materials are selected from the group consisting of ethylene-propylene rubber, butane-1 polymers and copolymers, ethylene vinyl acetate, which are used to disperse the energy put into the second layer.

8. The multi-layer adhesive film of claim 1, wherein the particulate filler is adapted to redox react with a small amount of the functional polar moiety opening up ionic bonding sites to allow ionic bonding to occur between the particular filler and the metal substrate.

9. The multi-layer adhesive film of claim 8, wherein the amount of particulate filler is varied depending on the size of the particulate filler.

10. The multi-layer adhesive film of claim 9, wherein the particulate filler reduces the amount of energy required to bond the thermoplastic adhesive to the metal substrate by remaining to take up volume to allow the surrounding thermoplastic adhesive to reach a molten state.

11. The multi-layer adhesive film of claim 10, wherein the particulate filler holds and stores the heat energy put into the first layer longer than the surrounding thermoplastic adhesive material.

12. The multi-layer adhesive film of claim 11, wherein the heat energy stored in the particulate filler is slowly released to increase the amount time required for the surrounding molten thermoplastic adhesive to re-solidify.

13. The multi-layer adhesive film of claim 12, wherein the slowed cooling and re-solidification of the molten thermoplastic adhesive allows for more covalent and ionic bonds to form between the polymer and the metal.

14. The multi-layer adhesive film of claim 1, wherein the particulate filler is selected from the group consisting of, talc, mica, alumina, wallastonite, clay, glass sphere, titania, nesosilicates, sorosilicates, cyclosilicates, inosilicates, inosilicates, silicates, phosphates, wood flour, and mixtures thereof.

15. The multi-layer adhesive film of claim 1, wherein the particulate filler has an average particle diameter from about 0.1 microns to about 100 microns.

16. The multi-layer adhesive film of claim 1, wherein hydrides are released from the particulate filler in the first layer when heated to form transition hydride metal complexes.

17. The multi-layer adhesive film of claim 1, wherein the thermoplastic material of the first layer is selected from the group consisting of polyethylene, polypropylene, copolymers of ethylene with alpha-olefins, copolymers of ethylene with ethelenically unsatured esters and their derivatives, and mixtures of the foregoing.

18. The multi-layer adhesive film of claim 17, wherein the polar moiety comprises an active ingredient selected from the group consisting of unsatured carboxylic acids, functional derivatives of carboxylic acids including anhydrides, esters, and amides, metals salts of unsatured carboxylic acids; and imides and mixtures thereof.

19. A rubberized metal substrate comprising:
a metal layer having a surface
a rubber layer having a surface;
a multi-layer polymer film positioned between the metal and rubber layers, the multi-layer polymer film having
a first layer formed from a thermoplastic adhesive containing a functional polar moiety and from about 0.1% to about 75% of volume by percent weight of a particulate filler, the first layer bonded to the surface of the metal layer through the application of heat; and
a second layer composed of a thermoplastic adhesive and a crosslinking agent, the second layer bonded to the surface of the rubber layer through the application of heat.
